(19) United States
(12) Patent Application Publication
(10) Pub. No.: US 2018/0165992 A1
(43) Pub. Date: Jun. 14, 2018

(54) FILTER AIRFLOW DEMONSTRATOR

(71) Applicant: K&N Engineering, Inc., Riverside, CA (US)

(72) Inventors: Steve Williams, Beaumont, CA (US); Jonathan R. Fiello, Yucaipa, CA (US); Jere James Wall, Helendale, CA (US)

(73) Assignee: K&N Engineering, Inc., Riverside, CA (US)

(21) Appl. No.: 15/375,956

(22) Filed: Dec. 12, 2016

(51) Int. Cl. G09B 25/02; B01D 46/00; B01D 46/10

(52) U.S. Cl. CPC G09B 25/02; B01D 46/0045; B01D 2279/60; B01D 2273/12; B01D 46/10

(57) ABSTRACT

An apparatus and a method are provided for a filter airflow demonstrator to provide a visual representation of resistance to air flow through an air filter. The airflow demonstrator comprises a housing that includes an opening configured to receive the air filter. An edge portion of the opening receives a perimeter of the air filter, such that a filter medium of the air filter is disposed over the opening. An electric fan within an interior of the housing draws the air flow through the filter medium into the housing. A transparent stand pipe is disposed atop the housing, such that a lumen of the stand pipe transports the air flow from the interior to an exterior of the housing. A ball within the central lumen travels upwards therein under the action of the air flow to provide an indication of resistance to the air flow through the air filter.

### FIELD

The field of the present disclosure generally relates to filtration devices. More particularly, the field of the invention relates to an apparatus and a method for a filter airflow demonstrator to provide a visual representation of air flow through an air filter.

### BACKGROUND

An air filter designed to remove particulate matter from an airstream generally is a device comprising fibrous materials. These fibrous materials may remove solid particulates such as dust, pollen, mold, and bacteria from the airstream. Air filters are used in applications where air quality is important, notably in ventilation systems of buildings and vehicles, as well as in engines.

Air filters may be used in automobiles, trucks, tractors, locomotives and other vehicles that use internal combustion engines. Air filters may be used with gasoline engines, diesel engines, or other engines that utilize fossil fuels or other combustible substances. Air filters may be used with engines in which combustion is intermittent, such as four-stroke and two-stroke piston engines, as well as other types of engines that take in air continuously so that a combustible substance may be burned. For example, air filters may be used with some gas turbines. Filters may also be used with air compressors or in other devices that take in air.

Filters may be made from pleated paper, foam, cotton, spun fiberglass, or other known filter materials. Generally the air filters used with internal combustion engines and compressors tend to be comprised of either: paper, foam, or cotton filters. Some filters use an oil bath. Air filters for internal combustion engines prevent abrasive particulate matter from entering the engine's cylinders, where it would cause mechanical wear and oil contamination. In many fuel injected engines, a flat panel pleated paper filter element may be used. This filter is usually placed inside a plastic box connected to the throttle body with ductwork. Vehicles that use carburetors or throttle body fuel injection typically use a cylindrical air filter positioned above the carburetor or throttle body.

Air filters may also be used to filter cabin air, for example, air within a vehicle such as a car, truck, airplane, bus, train, tractor, and the like. These air filters may typically be pleated-paper filters in which outside-air is passed through the filters before entering vehicle passenger compartments. Some of these filters are rectangular and similar in appearance to combustion air filters.

A drawback to paper air filters is that they must be thick, or the fibers must be tightly compressed and dense, which makes paper filters restrictive to air flow. Moreover, as a paper filter becomes more and more clogged with contaminants, the pressure downstream of the filter drops while the atmospheric air pressure outside the filter remains the same. When the pressure differential becomes too great, due to clogging, contaminants may be pulled through the restricted air filter into the engine. Thus, the performance of a paper air filter (i.e., air flow through the filter and its ability to protect the engine) decreases over the course of the filter's service life.

One way to reduce the clogging tendency of an air filter is by using a filter material having larger openings between the various fibers comprising the filter material. A suitable oil may be applied to the filter material, such that the fibers comprising the filter material become sufficiently tacky to cause smaller contaminants to cling to the fibers rather than passing through the air filter. Applying filter oil to relatively porous filter materials produces air filters offering advantageously decreased resistance to air flow during operation of the air filters. Decreased resistance to air flow is known to improve fuel economy and performance of internal combustion engines.

What is needed, however, is an apparatus that provides a visual representation of resistance to air flow through various differently-constructed air filters so as to incentivize consumers to purchase a preferred air filter in lieu of typical, more restrictive air filters.

### SUMMARY

An apparatus and a method are provided for a filter airflow demonstrator to provide a visual representation of air flow through an air filter. The airflow demonstrator comprises an enclosed housing that includes an opening configured to receive the air filter. An edge portion of the opening receives a perimeter of the air filter, such that a filter medium of the air filter is disposed over the opening. An electric fan within an interior of the housing draws the air flow through the filter medium into the housing. A transparent stand pipe is disposed atop the housing, such that a central lumen of the transparent stand pipe is in fluid communication with the interior of the housing. The transparent stand pipe transports the air flow from the interior to an exterior of the housing. A ball within the central lumen travels upwards therein under the action of the air flow, thereby providing a visual indication of resistance to air flow passing through the air filter. It is contemplated that differences in upward travel of the ball may serve to incentivize potential consumers to purchase a preferred air filter in lieu of purchasing typical, more restrictive air filters.

In an exemplary embodiment, a filter airflow demonstrator configured to provide a visual representation of air flow through an air filter comprises a housing including an opening configured to receive the air filter and a throttle opening configured to facilitate controlling air flow within the housing; an electric fan disposed within an interior of the housing and configured to draw air flow through the air filter into the interior; a transparent stand pipe disposed atop the housing, a central lumen of the transparent stand pipe being in fluid communication with the interior and configured to transport the air flow from the interior to an exterior of the housing; and a ball configured to travel upwards within the central lumen under the action of the air flow.

In another exemplary embodiment, the housing is comprised of an optically transparent, rigid material, such as Poly(methyl methacrylate) (PMMA), polycarbonate, or any of various transparent thermoplastics. In another exemplary embodiment, an interior wall separates a first chamber and a second chamber within the housing, the electric fan being mounted onto the interior wall such that the air flow is moved from the first chamber to the second chamber, the opening being disposed in the first chamber, and the throttle opening and the transparent stand pipe being disposed in the second chamber. In another exemplary embodiment, the opening is comprised of an edge portion that is configured to receive a perimeter of the air filter, such that a filter medium of the air filter is disposed over the opening, thereby allowing the air flow to pass through the filter medium and the opening into the interior.

In another exemplary embodiment, the transparent stand pipe is comprised of a rigid material, such as PMMA, polycarbonate, or any of various transparent thermoplastics. In another exemplary embodiment, the transparent stand pipe is coupled with the housing by way of any of various adhesives and/or suitable mechanical fasteners. In another exemplary embodiment, the suitable mechanical fasteners are comprised of a rubber grommet configured to be retained within an opening disposed on top of the housing and having an inner diameter configured to fixedly receive the transparent stand pipe. In another exemplary embodiment, a first keeper pin is disposed within a lower end of the transparent stand pipe and configured to prevent the ball from dropping into the interior of the housing, and wherein a second keeper pin is disposed within an upper end of the transparent stand pipe and configured to prevent the ball from exiting the transparent stand pipe under the action of the air flow.

In another exemplary embodiment, the filter airflow demonstrator further comprising a power supply configured to receive electric power from a power source and convey the electric power to an electric motor comprising the electric fan. In another exemplary embodiment, the electric fan is comprised of two or more blades configured to move the air flow upon being set in rotation by the electric motor. In another exemplary embodiment, a power cord is coupled at one end with the housing and configured to be extended to the power source. In another exemplary embodiment, a switch is disposed in the housing and electrically coupled between the power source and the electric motor, such that a practitioner may set the electric motor into operation. In another exemplary embodiment, the switch is of a variable variety and is configured to allow the practitioner to control an operational speed of the electric motor.

In an exemplary embodiment, a method for a filter airflow demonstrator configured to provide a visual representation of air flow through an air filter comprises fabricating a housing that includes an opening configured to receive the air filter and a throttle opening configured to facilitate controlling the air flow within the housing; orienting an electric fan within an interior of the housing; configuring the electric fan to draw air flow through the air filter into the interior; coupling a stand pipe atop the housing such that a lumen of the stand pipe is in fluid communication with the interior and configured to transport the air flow from the interior to an exterior of the housing; and positioning a ball within the stand pipe such that the ball travels upwards within the lumen under the action of the air flow.

In another exemplary embodiment, coupling comprises attaching the stand pipe to the housing by way of any of various adhesives and/or suitable mechanical fasteners. In another exemplary embodiment, configuring further comprises providing a power supply configured to receive electric power from a power source and convey the electric power to an electric motor comprising the electric fan. In another exemplary embodiment, configuring further comprises electrically coupling a switch between the power source and the electric motor, such that a practitioner may set the electric motor into operation. In another exemplary embodiment, electrically coupling further comprises configuring the switch to allow the practitioner to control an operational speed of the electric motor. In another exemplary embodiment, orienting comprises mounting the electric fan within the interior, such that two or more blades comprising the electric fan move the air flow upon being set in rotation by the electric motor. In another exemplary embodiment, providing a power supply further comprises configuring a power cord to extend from the power supply to the power source, the power cord being coupled at one end with the housing and being suitable for conveying the electric power.

### BRIEF DESCRIPTION OF THE DRAWINGS

The drawings refer to embodiments of the present disclosure in which:

FIG. 1 illustrates a perspective view of an exemplary embodiment of a filter airflow demonstrator configured to provide a visual representation of resistance to air flow through an air filter;

FIG. 2 illustrates a perspective view of the exemplary embodiment of the filter airflow demonstrator illustrated in FIG. 1 in absence of the air filter;

FIG. 3 illustrates a rearward perspective view of the exemplary embodiment of the filter airflow demonstrator illustrated in FIG. 1; and

FIG. 4 illustrates a top view of the exemplary embodiment of the filter airflow demonstrator of FIG. 1.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the invention disclosed herein may be practiced without these specific details. In other instances, specific numeric references such as “first filter,” may be made. However, the specific numeric reference should not be interpreted as a literal sequential order but rather interpreted that the “first filter” is different than a “second filter.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes an apparatus and a method for a filter airflow demonstrator to provide a visual representation of air flow through an air filter. The airflow demonstrator comprises a housing that includes an opening configured to receive and retain the air filter. An edge portion of the opening receives a perimeter of the air filter, such that a filter medium of the air filter is disposed over the opening, thereby allowing the air flow to pass through the filter medium and the opening into the interior of the housing. A throttle opening in the housing facilitates controlling air flow within the housing and through the air filter. An electric fan within the interior of the housing is configured to draw the air flow through the filter medium into the interior of the housing. A power supply is configured to receive electric power from a power source and convey the electric power to an electric motor comprising the electric fan. A power cord may be coupled at one end with the housing and configured to be extended to the power source. Preferably, a switch is disposed in the housing and electrically coupled between the power supply and the electric motor, such that a practitioner may set the electric motor into operation. A transparent stand pipe is disposed atop the housing, such that a central lumen of the stand pipe is in fluid communication with the interior of the housing. The stand pipe is configured to transport the air flow from the interior to an exterior of the housing. A ball is disposed within the central lumen and configured to travel upwards therein under the action of the air flow.

Although embodiments of the invention may be described and illustrated herein in terms of a flat, panel-shaped automotive air filter, it should be understood that embodiments of this invention are not limited to use with the exact shape of the air filter illustrated, but rather may be configured for use with a wide variety of differently shaped air filters, such as, but not limited to generally cylindrical shapes, generally circular, oval, round, curved, conical, or other closed perimeter shapes, that provide a relatively large surface area in a given volume of the filter. Moreover, embodiments as described herein are not limited to use with automotive air filters, but may be configured for use with air filters having applicability in other filtration systems in which a large volumes of air need to be treated.

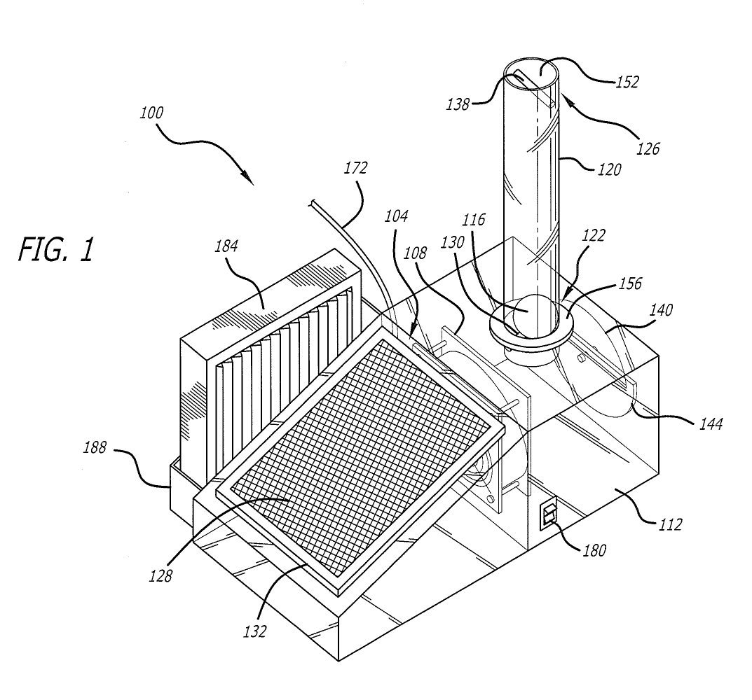

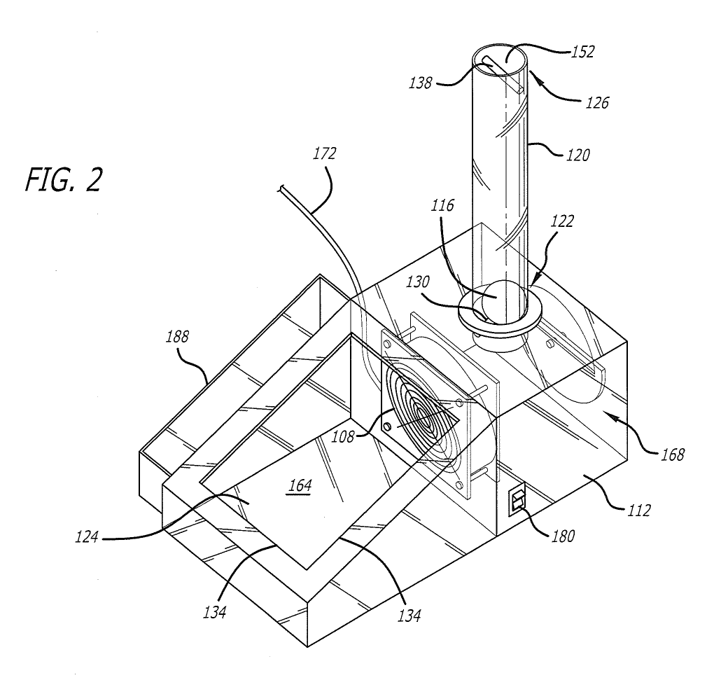

FIGS. 1 and 2 illustrate perspective views of an exemplary embodiment of a filter airflow demonstrator 100 configured to provide a visual representation of resistance to air flow through an air filter 104. The filter airflow demonstrator 100 generally is comprised of an electric fan 108 that is configured to draw air through the air filter 104 into a housing 112, such that the air pushes a ball 116 upward within a transparent stand pipe 120 disposed atop the housing. The housing 112 and the transparent stand pipe 120 preferably are comprised of an optically transparent, rigid material, such as Poly(methyl methacrylate) (PMMA), polycarbonate, or any of various other transparent thermoplastics. As will be appreciated, the transparency of the material comprising the housing 112 and the transparent stand pipe 120 facilitate direct observation of the position and behavior of the ball 116 during operation of the filter airflow demonstrator 100.

As best shown in FIG. 2, the housing 112 includes an opening 124 that is configured to receive the air filter 104. The air filter 104 generally is comprised of a filter medium 128 that is retained within a perimeter 132 suitable for supporting the air filter such that air may be passed through the filter medium. In the illustrated embodiment, the opening 124 is comprised of an edge portion 134 that is configured to receive the perimeter 132 of the air filter 104, such that the filter medium 128 is disposed over the opening. During operation of the filter airflow demonstrator 100, the air flow passes through the filter medium 128 and the opening 124 into an interior of the housing 112. It should be understood that the filter airflow demonstrator 100 need not be limited to use with flat, panel-shaped air filters, such as the air filter 104, but rather the filter airflow demonstrator 100 may be configured for being coupled with air filters other than the air filter 104, such as, any of various air filters that provide a relatively large surface area in a given volume of the filter, as well as any of various air filters having applicability in other filtration systems in which a large volume of air needs to be treated.

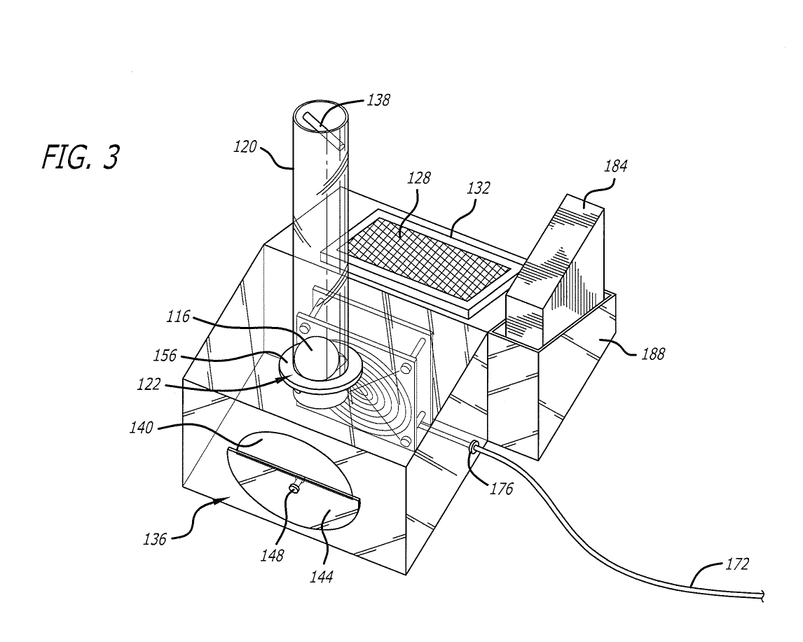

As best shown in FIG. 3, the housing 112 is comprised of a throttle opening 136 that is configured to facilitate controlling air flow within the housing. As will be appreciated, fully opening the throttle opening 136 allows air flow from the electric fan 108 to exit the housing 112, thereby largely bypassing the transparent stand pipe 120. Thus, in absence of sufficient air flow, the ball 116 remains at a bottom 122 of the transparent stand pipe 120. Alternatively, completely closing the throttle opening 136 directs substantially an entirety of the air flow through the transparent stand pipe 120, thus forcing the ball 116 to a top 126 of the transparent stand pipe.

In the illustrated embodiment, the throttle opening 136 is comprised of an opening 140 in the housing 112 and a movable panel 144. A pivot 148 attaches the movable panel 144 to the housing 112, such that a practitioner of the filter airflow demonstrator 100 may rotate the movable panel 144 about the pivot 148 to cover the opening 140, thereby controlling the air flow that is directed to the transparent stand pipe 120. The pivot 148 preferably offers a suitable degree of friction to maintain the movable panel 144 in any selected position relative to the opening 140. In some embodiments, the throttle opening 136 may be comprised of a butterfly valve disposed within a circular opening whereby rotating the butterfly valve correspondingly controls the air flow to the transparent stand pipe 120. It is contemplated that the throttle opening 136 may be comprised of any suitable mechanism whereby air flow directed to the transparent stand pipe 120 may be desirably controlled, without limitation.

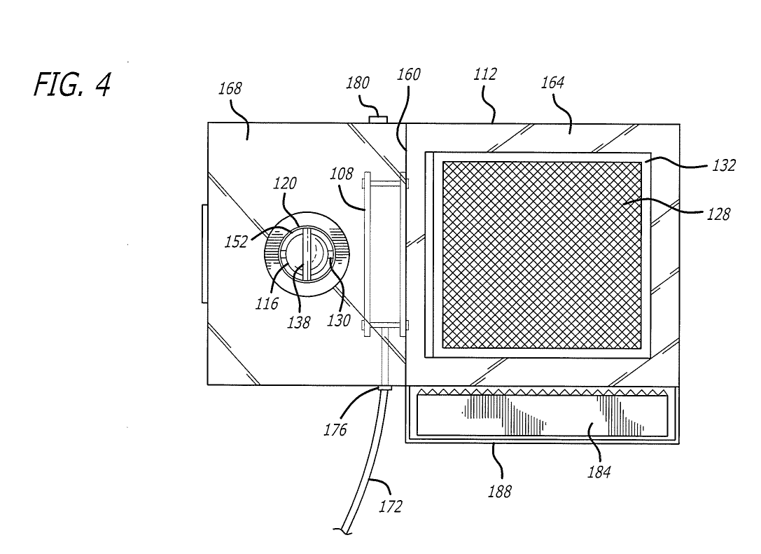

As best shown in FIG. 4, the transparent stand pipe 120 is comprised of a central lumen 152 that is placed into fluid communication with the interior of the housing 112. The central lumen 152 preferably has an inner diameter that is greater than the diameter of the ball 116. As will be recognized, the difference in diameter between the central lumen 152 and the ball 116 ensures that the ball is free to move within the central lumen while the air flow from the interior of the housing 112 passes around the ball 116 and exits the transparent stand pipe 120. In the embodiment illustrated in FIGS. 1-4, the ball 116 is comprised of a ping-pong ball. It is contemplated, however, that the ball 116 may be comprised of any lightweight ball that is suitable for demonstrating resistance to air flow through the air filter 104. Moreover, a first keeper pin 130 disposed at the bottom 122, within the central lumen 152, is configured to prevent the ball 116 from dropping into the interior of the housing 112. A second keeper pin 138 disposed within the central lumen 152, at the top 126, is configured to prevent the ball 116 from exiting the transparent stand pipe 120 under the action of the air flow.

In the embodiment illustrated in FIGS. 1-4, a rubber grommet 156 retains the transparent stand pipe 120 within an opening disposed on top of the housing 112. The rubber grommet 156 is comprised of an inner diameter configured to fixedly receive the transparent stand pipe 120, such that the bottom 122 extends into the housing 112 and the central lumen 152 is in fluid communication with the interior of the housing, as described above. It is envisioned that in other embodiments, the transparent stand pipe 120 may be coupled with the housing 112 by way of any of various adhesives and/or suitable mechanical fasteners, without limitation.

As described above, the electric fan 108 is configured to draw air through the air filter 104 into the housing 112 so as to push the ball 116 upward within the transparent stand pipe 120. In general, the electric fan 108 is comprised of two or more blades configured to move the air flow upon being set in rotation by an electric motor. As best shown in FIGS. 2 and 4, the electric fan 108 is mounted onto an interior wall 160 that separates a first chamber 164 and a second chamber 168 within the interior of the housing 112. The first chamber 164 includes the opening 124 that receives the air filter 104, and the second chamber 168 includes the throttle opening 136 and the bottom 122 of the transparent stand pipe 120. Thus, in addition to providing a structure for mounting the electric fan 108, the interior wall 160 ensures that the air flow is controllably passed through the opening 124 into the first chamber 164, and then is moved into the second chamber 168 before exiting through the throttle opening 136 and the transparent stand pipe 120 without any backflow of air into the first chamber 164. As will be recognized, therefore, all air flow being directed to move the ball 116 within the transparent stand pipe 120 and to exit through the throttle opening 136 is first passed through the air filter 104.

In some embodiments, a power supply may be disposed within either of the first and second chambers 164, 168 and configured to receive electric power from a power source and convey the electric power to the electric motor comprising the electric fan 108. Preferably, the power source is comprised of an AC electrical source, such as a wall outlet, although DC battery-powered sources may be implemented without limitation. In the illustrated embodiment of FIGS. 1-4, however, a separate power supply is omitted in lieu of the electric fan 108 being configured to receive AC electric power by way of a power cord 172 that is configured to be extended to an AC wall outlet. As shown in FIG. 3, the power cord 172 may be coupled at one end with the housing 112 by way of a grommet 176, or other suitable mechanical means. As shown in FIGS. 1-2, a switch 180 may be disposed in the housing 112 and electrically coupled with the power cord 172 and the electric fan 108, such that a practitioner may set the electric fan into operation. In some embodiments, the switch 180 may be of the variable variety, and thus configured to allow the practitioner to control an operational speed of the electric fan 108, without limitation, and without deviating beyond the spirit and scope of the present disclosure.

It is contemplated that during operation of the filter airflow demonstrator 100, the air filter 104 may be comprised of a typical air filter that a practitioner desires to compare with a preferred air filter 184. In some embodiments, the housing 112 may further include a side pocket 188 configured to loosely receive either of the typical or preferred air filters 104, 184. During operation, the practitioner may begin by removing the typical air filter 104 from the opening 124, fully opening the throttle opening 136, and pressing the switch 180 to set the electric fan 108 into operation. The practitioner may position the preferred air filter 184 into the opening 124 and then close the throttle opening 136 until the ball 116 is positioned at a desired location near the top 126 of the transparent stand pipe 120, such as, by way of non-limiting example, one inch below the second keeper pin 138. Next, the practitioner may remove the preferred air filter 184 and place the typical air filter 104 into the opening 124, whereby increase a resistance to air flow through the typical air filter 104 causes the ball 116 to drop to a lower position within the transparent stand pipe 120. It is contemplated that the practitioner may bring to the attention of potential consumers that the resistance to air flow of the preferred air filter 184 is advantageously lower than the resistance to air flow of the typical air filter 104, thereby providing an incentive to purchase the preferred air filter 184 in lieu of the typical air filter 104.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A filter airflow demonstrator configured to provide a visual representation of air flow through an air filter, comprising:
a housing including an opening configured to receive the air filter and a throttle opening configured to facilitate controlling air flow within the housing;
an electric fan disposed within an interior of the housing and configured to draw air flow through the air filter into the interior;
a transparent stand pipe disposed atop the housing, a central lumen of the transparent stand pipe being in fluid communication with the interior and configured to transport the air flow from the interior to an exterior of the housing; and
a ball configured to travel upwards within the central lumen under the action of the air flow.

2. The demonstrator of claim 1, wherein the housing is comprised of an optically transparent, rigid material, such as Poly(methyl methacrylate) (PMMA), polycarbonate, or any of various transparent thermoplastics.

3. The demonstrator of claim 1, wherein an interior wall separates a first chamber and a second chamber within the housing, the electric fan being mounted onto the interior wall such that the air flow is moved from the first chamber to the second chamber, the opening being disposed in the first chamber, and the throttle opening and the transparent stand pipe being disposed in the second chamber.

4. The demonstrator of claim 1, wherein the transparent stand pipe is comprised of a rigid material, such as PMMA, polycarbonate, or any of various transparent thermoplastics.

5. The demonstrator of claim 4, wherein the transparent stand pipe is coupled with the housing by way of any of various adhesives and/or suitable mechanical fasteners.

6. The demonstrator of claim 5, wherein the suitable mechanical fasteners are comprised of a rubber grommet configured to be retained within an opening disposed on top of the housing and having an inner diameter configured to fixedly receive the transparent stand pipe.

7. The demonstrator of claim 4, wherein a first keeper pin is disposed within a lower end of the transparent stand pipe and configured to prevent the ball from dropping into the interior of the housing, and wherein a second keeper pin is disposed within an upper end of the transparent stand pipe and configured to prevent the ball from exiting the transparent stand pipe under the action of the air flow.

8. The demonstrator of claim 1, wherein the opening is comprised of an edge portion that is configured to receive a perimeter of the air filter, such that a filter medium of the air filter is disposed over the opening, thereby allowing the air flow to pass through the filter medium and the opening into the interior.

9. The demonstrator of claim 1, further comprising a power supply configured to receive electric power from a power source and convey the electric power to an electric motor comprising the electric fan.

10. The demonstrator of claim 9, wherein the electric fan is comprised of two or more blades configured to move the air flow upon being set in rotation by the electric motor.

11. The demonstrator of claim 9, wherein a power cord is coupled at one end with the housing and configured to be extended to the power source.

12. The demonstrator of claim 9, wherein a switch is disposed in the housing and electrically coupled between the power source and the electric motor, such that a practitioner may set the electric motor into operation.

13. The demonstrator of claim 12, wherein the switch is of a variable variety and is configured to allow the practitioner to control an operational speed of the electric motor.

14. A method for a filter airflow demonstrator configured to provide a visual representation of air flow through an air filter, comprising:
fabricating a housing that includes an opening configured to receive the air filter and a throttle opening configured to facilitate controlling the air flow within the housing;
orienting an electric fan within an interior of the housing;
configuring the electric fan to draw air flow through the air filter into the interior;
coupling a stand pipe atop the housing such that a lumen of the stand pipe is in fluid communication with the interior and configured to transport the air flow from the interior to an exterior of the housing; and
positioning a ball within the stand pipe such that the ball travels upwards within the lumen under the action of the air flow.

15. The method of claim 14, wherein coupling comprises attaching the stand pipe to the housing by way of any of various adhesives and/or suitable mechanical fasteners.

16. The method of claim 14, wherein configuring further comprises providing a power supply configured to receive electric power from a power source and convey the electric power to an electric motor comprising the electric fan.

17. The method of claim 16, wherein configuring further comprises electrically coupling a switch between the power source and the electric motor, such that a practitioner may set the electric motor into operation.

18. The method of claim 17, wherein electrically coupling further comprises configuring the switch to allow the practitioner to control an operational speed of the electric motor.

19. The method of claim 16, wherein orienting comprises mounting the electric fan within the interior, such that two or more blades comprising the electric fan move the air flow upon being set in rotation by the electric motor.

20. The method of claim 16, wherein providing a power supply further comprises configuring a power cord to extend from the power supply to the power source, the power cord being coupled at one end with the housing and being suitable for conveying the electric power.
